(19) United States
(12) Patent Application Publication
(10) Pub. No.: US 2025/0157428 A1
(43) Pub. Date: May 15, 2025

(54) DIGITAL ROOM MIRROR CONTROL APPARATUS OF A VEHICLE AND CONTROL METHOD THEREOF

(71) Applicant: THINKWARE CORPORATION, Seongnam-si (KR)

(72) Inventors: Hyun Chul CHO, Seongnam-si (KR); Tae Jin KIM, Seongnam-si (KR); Soon Woo PARK, Seongnam-si (KR); Hyun Jin BANG, Seongnam-si (KR); Jong Hoon LEE, Seongnam-si (KR); Hae Jong CHOI, Seongnam-si (KR)

(21) Appl. No.: 18/897,503

(22) Filed: Sep. 26, 2024

(30) Foreign Application Priority Data
Sep. 27, 2023 (KR) 10-2023-0130770
Oct. 6, 2023 (KR) 10-2023-0133356
Oct. 31, 2023 (KR) 10-2023-0148588
Sep. 26, 2024 (KR) 10-2024-0130996

(51) Int. Cl. G09G 3/36; B60R 1/12; B60R 1/22

(52) U.S. Cl. CPC G09G 3/36; B60R 1/12; B60R 1/22; B60R 2001/1215; B60R 2001/1253; B60R 2300/308; B60R 2300/804; B60R 2300/8066; G09G 2320/068; G09G 2340/14; G09G 2354/00; G09G 2380/10

(57) ABSTRACT

Disclosed are a digital room mirror control apparatus of a vehicle and a control method thereof, which may improve the convenience and safety of a driver by displaying an object on a digital room mirror of the vehicle or controlling the displayed object based on an external environment of the vehicle or a speed of the vehicle.

### CROSS-REFERENCE TO RELATED APPLICATION(S)

This application claims benefit of priority to Korean Patent Application Nos. 10-2023-0130770, filed Sep. 27, 2023; 10-2023-0133356, filed Oct. 6, 2023; 10-2023-0148588 filed Oct. 31, 2023; and 10-2024-0130996 filed Sep. 26, 2024; the disclosure of each of which are incorporated herein by reference in their entirety.

### TECHNICAL FIELD

The present disclosure relates to a digital room mirror control apparatus of a vehicle for displaying an object on a digital room mirror of a vehicle or controlling the displayed object based on an external environment of the vehicle or a speed of the vehicle, and a control method thereof.

### TECHNOLOGY BACKGROUND OF THE INVENTION

In general, a vehicle may be mounted with left and right side mirrors and a room mirror (rearview mirror) to check a rear state of the vehicle to provide driving convenience and stability, and each of these mirrors may be adjusted to various angles based on the body type and driving habit of a driver, thus providing the driver with a secured rear view.

A conventional analog room mirror may be operated by reflecting a situation behind the vehicle, and this method has several limitations. For example, the driver may experience glare if a following vehicle emits strong headlights when driving at night, or have a rear view interfered by large cargo or a rear-seat passenger.

In addition, the rear view that the driver may secure may be limited based on the size and installation location of the room mirror, thus creating a need for a new technical solution to solve this problem.

To solve this problem, the digital room mirror has been developed. The digital room mirror may use a manner in which a camera mounted on the rear of the vehicle captures an image in real time and output the same to a display installed at the vehicle to thus directly display a rear image instead of an existing reflective mirror. The digital room mirror may thus provide a wide viewing angle and minimize a visual interference caused by light reflection or an external object.

However, with the introduction of the digital room mirror, technology has become important for controlling a camera image to be accurately reflected in real time. For example, there is a need for a technical solution for enabling the driver to be always provided with a secured optimal rear view by controlling various factors such as the quality, brightness adjustment, distortion correction, and screen transition speed of the camera image. This technology may need to be designed to ensure reliable performance under a variety of driving conditions, including a weather condition, a lighting change, and a speed of the vehicle.

In addition, this technology may need to be designed to appropriately display an object on the display of the digital room mirror, which has a physically limited size, for the safety and convenience of a user.

Consequently, a control method of a digital room mirror may be a technology developed to maximize the safety and convenience of the driver, and include various technical solutions for manipulating and controlling the camera and the display to secure the rear view.

### CONTENTS OF THE INVENTION

### Problems to be Solved

An object of the present disclosure is to solve the above-mentioned problems.

An object of the present disclosure is to provide a digital room mirror control apparatus of a vehicle that is capable of displaying external environment information based on a vehicle location on a digital room mirror of a vehicle for convenience of a driver, and a control method thereof.

Another object of the present disclosure is to provide a digital room mirror control apparatus of a vehicle that is capable of displaying external environment information on a digital room mirror under a predetermined condition for the driver's safety and simultaneously providing a driver with a notification, and a control method thereof.

Still another object of the present disclosure is to provide a digital room mirror control apparatus of a vehicle that displays a guide line on a digital room mirror by considering a speed of the vehicle, whether another vehicle approaches, whether a lane marking change signal is detected, or the like for the driver's safety, and a control method thereof.

### Means for Solving the Problem

According to an embodiment of the present disclosure, provided is a control method of a digital room mirror of a vehicle, the method including: determining whether a reverse signal of the vehicle is detected through a transmission device; checking vehicle location information if the reverse signal is not detected; receiving external environment information based on the vehicle location information; and determining whether the external environment information corresponds to a predetermined condition, wherein the external environment information on the room mirror is displayed by a control unit of the vehicle, based on whether the external environment information corresponds to the predetermined condition.

The external environment information may include weather information, traffic condition information, or the like based on the vehicle location information.

The external environment information may be displayed on the room mirror and a notification is provided to a driver, by the control unit, if the external environment information corresponds to the predetermined condition.

A notification may be displayed on the room mirror.

According to an embodiment of the present disclosure, provided is a control method of a digital room mirror of a vehicle, the method including: measuring a speed of the vehicle; comparing the measured speed of the vehicle with a predetermined reference speed; displaying a guide line on the digital room mirror by a control unit of the vehicle if the measured speed of the vehicle is a predetermined reference speed or more; and detecting another vehicle approaching the vehicle, wherein a position of the guide line is adjusted by the control unit when another vehicle approaching the vehicle in driving is detected.

The pair of guidelines may be displayed on the room mirror based on lane markings of the vehicle in driving.

The plurality of pairs of guide lines may be displayed when another approaching vehicle is detected.

The guide lines may include the pair of first guide lines displayed based on the lane markings of the vehicle in driving, and the pair of second guide lines displayed at positions respectively spaced apart from the lane markings in directions away from the lane markings based on the pair of first guide lines.

The second guide line may be displayed by being moved in a direction closer to the first guide line as the speed of the vehicle is increased.

The method may further include determining whether a lane marking change signal of the vehicle in driving is detected if another vehicle is detected.

The plurality of pairs of guide lines may be displayed when the lane marking change signal is detected.

The guide lines may include the pair of first guide lines displayed based on the lane markings of the vehicle in driving, and the pair of second guide lines displayed at positions respectively spaced apart from the lane markings in directions away from the lane markings based on the pair of first guide lines.

The second guide line may be displayed by being moved in a direction closer to the first guide line as the speed of the vehicle is increased.

According to an embodiment of the present disclosure, provided is a program stored on a computer-readable recording medium including a program code for executing a control method of a digital room mirror of a vehicle as described above.

According to an embodiment of the present disclosure, provided is a computer-readable recording medium including a program code for executing a control method of a digital room mirror of a vehicle as described above.

According to an embodiment of the present disclosure, provided is a digital room mirror control apparatus of a vehicle, the apparatus including: a digital room mirror driven in at least two modes based on an electrical signal that is selectively input; a sensor unit for detecting a speed of the vehicle in driving, approach of another vehicle, or a lane marking change signal of the vehicle in driving; a camera for capturing an external environment of the vehicle; and a control unit for generating a captured image or an object for the convenience and safety of a driver and displaying the generated image or object on the digital room mirror, wherein the control unit displays a guide line on the digital room mirror based on at least one of the speed of the vehicle in driving, the approach of another vehicle, or the lane marking change signal of the vehicle in driving that is measured through the sensor unit.

The pair of guidelines may be displayed on the room mirror based on lane markings of the vehicle in driving.

The plurality of pairs of guide lines may be displayed when detecting another approaching vehicle.

The guide lines may include the pair of first guide lines displayed based on the lane markings of the vehicle in driving, and the pair of second guide lines displayed at positions respectively spaced apart from the lane markings in directions away from the lane markings based on the pair of first guide lines.

The second guide line may be displayed by being moved in a direction closer to the first guide line as the speed of the vehicle is increased.

Each feature of the embodiments described above may be implemented in combination in other embodiments as long as the feature does not contradict or exclude other embodiments.

### Effects of the Invention

According to the various embodiments of the present disclosure, the digital room mirror control apparatus of a vehicle and the control method thereof may improve the driving convenience and safety of the driver by displaying the various information based on the situation on the digital room mirror of a vehicle.

Advantageous effects of the present disclosure are not limited to those mentioned above, and other effects not mentioned here may be obviously understood by those skilled in the art from the description provided above.

### BRIEF DESCRIPTION OF DRAWINGS

FIGS. 1 and 2 are diagrams each showing a structure of a mirror display according to an embodiment of the present disclosure.

FIG. 3 is a diagram showing a configuration of a digital room mirror control apparatus of a vehicle according to an embodiment of the present disclosure.

FIGS. 4(a)-4(c) are diagrams showing a control mode of the digital room mirror of a vehicle according to an embodiment of the present disclosure.

FIG. 5 is a diagram showing a control method of a digital room mirror of a vehicle according to an embodiment of the present disclosure.

FIGS. 6 to 8 are diagrams each showing an object displayed on the digital room mirror of a vehicle according to an embodiment of the control method in FIG. 5.

FIG. 9 is a diagram showing a control method of a digital room mirror of a vehicle according to an embodiment of the present disclosure.

FIG. 10 is a diagram showing a control method of a digital room mirror of a vehicle according to an embodiment of the present disclosure.

FIGS. 11 to 13 are diagrams each showing an object displayed on the digital room mirror of a vehicle according to the control method in FIG. 9 or FIG. 10.

FIG. 14 is a block diagram showing a vehicle mounted with the digital rear mirror device according to an embodiment of the present disclosure.

FIG. 15 is a block diagram showing a control apparatus of the vehicle in FIG. 14.

### DETAILED DESCRIPTION

Hereinafter, specific embodiments of the present disclosure are described with reference to the accompanying drawings. A detailed description below is provided to facilitate comprehensive understanding of a method, an apparatus, and/or a system, described in the specification. However, the embodiments are only described by way of examples and the present disclosure is not limited thereto.

In describing the embodiments of the present disclosure, omitted is a detailed description of a case where it is decided that the detailed description of the known functions or configurations related to the present disclosure may unnecessarily obscure the gist of the present disclosure. In addition, terms described below are defined in consideration of their functions in the present disclosure, and may be construed in different ways by intentions of users or operators, practices, or the like. Therefore, the terms should be defined on the basis of the contents described throughout the specification.

Terms used in the detailed description are provided merely to describe the embodiments of the present disclosure, and should not be construed to be restrictive. A term of a single number may include its plural number unless explicitly indicated otherwise.

It should be understood that terms “include”, “have”, or the like used in the specification specify certain features, numerals, steps, operations, elements, portions, or combinations thereof, and it should not be construed to exclude the presence or possibility of one or more other features, numbers, steps, operations, elements, portions, or combinations thereof other than those described.

In addition, terms “first”, “second”, A, B, (a), (b), and the like, may be used in describing components of an embodiment of the present disclosure. These terms are used only in order to distinguish any components from other components, and features, sequences, or the like of the corresponding components are not limited to these terms.

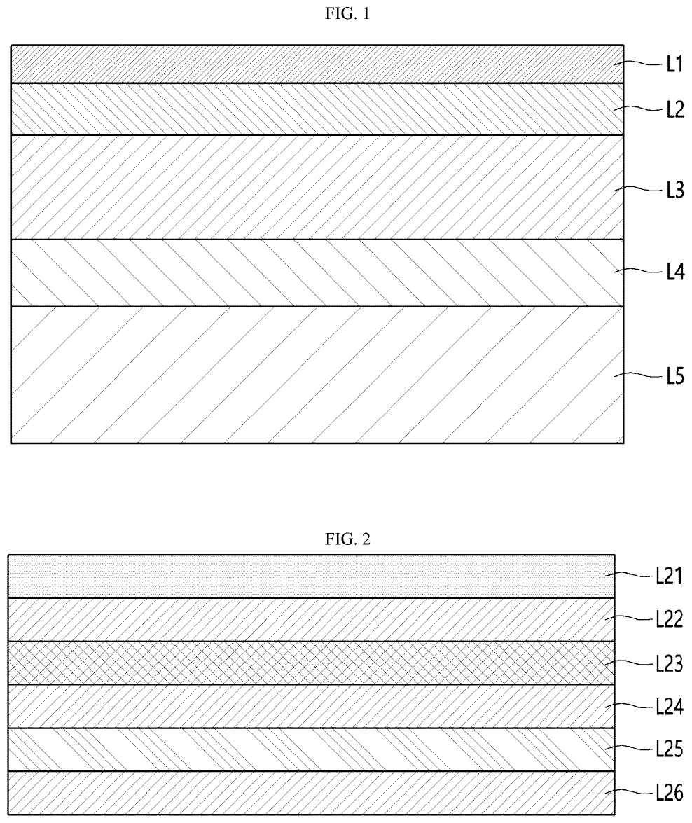

FIGS. 1 and 2 are diagrams each showing a structure of a mirror display according to an embodiment of the present disclosure.

Referring to FIG. 1, a mirror display according to an embodiment of the present disclosure may be formed by stacking a coating layer L1, an upper polarizer L2, a liquid crystal display panel L3, a lower polarizer L4, and a backlight L5, and referring to FIG. 2, the upper polarizer L2 may be formed by stacking a protective layer L21, a triacetyl cellulose (TAC) layer L22, a mirror film L23, a TAC layer L24, a polyvinyl alcohol (PVA) layer L25, and a TAC layer L26.

In more detail, the coating layer L1 may indicate a layer formed of at least one of various coating solutions for improving performance of the mirror display, and may include, for example, an anti-reflective (AR) coating solution, an oleophobic coating solution, a hydrophobic coating solution, a scratch-resistant coating solution, or an ultraviolet (UV)-blocking coating solution.

The anti-reflective coating solution may reduce light reflection that may occur on a display screen, thus allowing a driver to see the screen more clearly. The oleophobic coating solution may inhibit fingerprints or oil stains from easily appearing on a display surface. The hydrophobic coating solution may inhibit moisture or water droplets from remaining on the display surface, thus inhibiting condensation caused by moisture or a rapid temperature change inside a vehicle.

In addition, the scratch-resistant coating solution may protect the display from being damaged by external impact or friction and function to increase long-term durability, and the UV-blocking coating solution may inhibit the screen from being discolored or damaged by ultraviolet (UV) rays when the display is exposed to sunlight for a long time.

The upper polarizer L2 may include several layers to maintain polarization performance of the display, respond to an external environment, and provide a user with a clear screen, and each layer may perform a specific function, which may be described below with reference to FIG. 2.

The liquid crystal display panel L3 may clearly display an image received from a rear camera 161 in real time, provide a wide viewing angle, and may automatically adjust its brightness for day and night. In addition, the liquid crystal display panel L3 may inhibit glare caused by strong light, and may accurately convey a rear situation with a high-resolution image quality and a fast response speed.

The lower polarizer L4 may function as a filter that allows light to pass through only in a specific direction by controlling a light vibration direction to optimize the performance of the display. In particular, the lower polarizer L4 may function to transmit light generated from the backlight L5 in the specific direction, and be operated together with the upper polarizer L2 to adjust the transmission and blocking of light, thereby providing a clear image on the display.

In addition, a liquid crystal display (LCD) panel itself does not emit light, and the image may be visualized by light provided from behind the screen through the backlight L5. For example, the backlight L5 may provide high efficiency and high brightness by using light-emitting diodes.

Meanwhile, in the upper polarizer L2, the protective layer L21, the triacetyl cellulose (TAC) layer L22, the mirror film L23, the TAC layer L24, the polyvinyl alcohol (PVA) L25, and the TAC layer L26 may be stacked between the coating layer L1 and the liquid crystal display panel L3.

The protective layer L21 may protect a polarizing film from physical impact or scratches, and inhibit deformation due to moisture and heat, thereby increasing durability of the film. For example, the protective layer L21 may inhibit the film from being damaged or discolored by direct sunlight through its ultraviolet (UV) blocking function. In addition, the protective layer may maintain optical transparency of the film while performing the functions described above, thereby maintaining the clarity and brightness of the screen.

The TAC layers L22, L24, and L26 may be sequentially arranged between the mirror film L23 and the TAC layer L24 to protect the mirror film L23 and the TAC layer L24.

The mirror film L23 may perform an important function of providing a reflection function like a general mirror even when a digital display is turned off. The mirror film using a half mirror structure may partially transmit and partially reflect light, thus allowing the digital display to display the image from the rear camera when turned on and to function as the mirror when turned off. In this way, the digital room mirror may be used as a hybrid device that simultaneously provides both digital image display and traditional mirror functions, thus allowing the driver to flexibly use both the functions based on the situation. As a result, the mirror film may increase versatility of the display, and provide a convenient solution that may use both digital and analog functions as needed.

The TAC layers L22 and L24 may be disposed above and below the mirror film L23 to thus protect the mirror film L23 from moisture, UV rays, physical impact, or the like, thereby inhibiting damage and increasing durability of the film. In addition, the TAC layers L22 and L24 may also function to maintain the optical transparency of the film without interfering with the light transmission, thereby ensuring a clear image quality of the display.

The PVA layer L25 may adjust the light vibration direction and polarize the light to pass through only in the specific direction for the display to provide the clear image. Through this process, the PVA layer L25 may function to accurately display the image received from the rear camera and reduce the glare to improve the driver's viewing angle.

However, the PVA layer L25 is very sensitive to moisture, UV, and physical impact, thus requiring the TAC layers L24 and L26 for its protection. The TAC layers L24 and L26 may be stacked above and below the PVA layer L25, and function as a protective film to inhibit the PVA layer L25 from being damaged or having a lower function due to the external environment. The TAC layers L24 and L26 may block moisture and UV rays and protect the PVA layer L25 from the physical impact, while maintaining the optical transparency of the film to assist in inhibiting light distortion.

Through the structure described above, the digital room mirror in this embodiment may stably maintain the function of the polarizing film even in various environments and provide a clear image quality and excellent visibility.

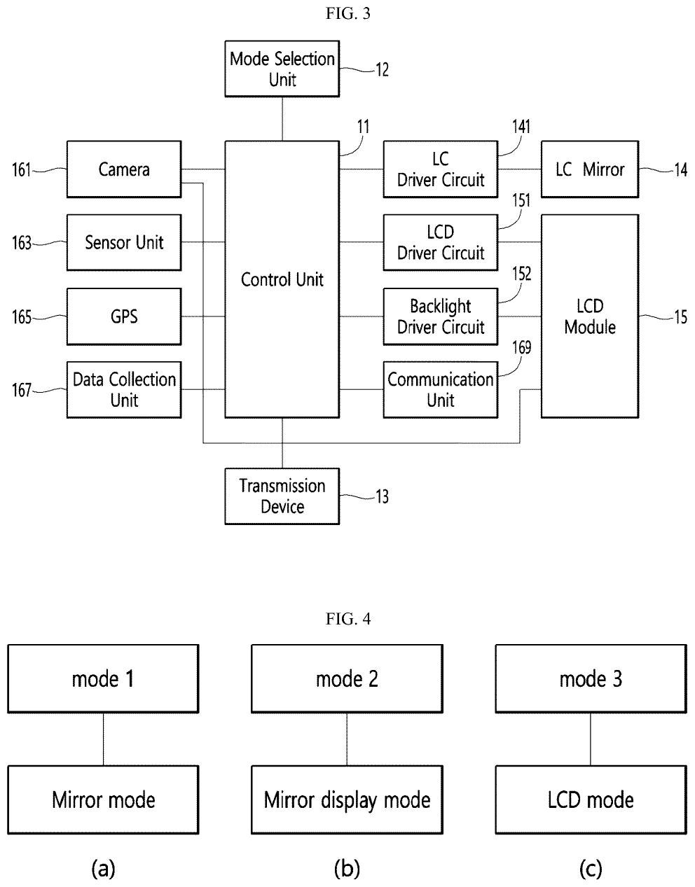

FIG. 3 is a diagram showing a configuration of the digital room mirror control apparatus of a vehicle according to an embodiment of the present disclosure.

A digital room mirror control apparatus 10 may perform complex functions of providing the driver with the rear view in real time through interconnection of various components and controlling this provision. Each component may be closely connected to each other while functioning independently, contributing to accurately and efficiently showing the rear situation while the vehicle drives, and may also provide the driver with necessary information from external environment information as needed.

Each component may be described below in more detail with reference to FIG. 3.

The camera 161 may be mounted at the rear of the vehicle, and may capture, for example, the rear situation of the vehicle in real time and transmit the image to a data collection unit. The camera 161 may detect an obstacle, a road condition, or the like at the rear and allow the driver to visually check the same. The camera 161 may be connected to a control unit 11, and the control unit 11 may adjust the screen of the digital room mirror based on a mode selected through a mode selection unit 12.

A sensor unit 163 may collect or detect data such as a light condition (brightness), the speed of the vehicle, a driving distance, a lane marking change signal, or the like to thus provide information suitable for the driving condition. For example, the control unit 11 may display the guide line (or the object) on the digital room mirror or adjust the location, brightness, or the like of the displayed object based on the speed of the vehicle or the lane marking change signal, detected through the sensor unit 163.

A global positioning system (GPS) 165 may track a real-time location of the vehicle, and check a current road condition and driving location. In this way, the GPS 165 may provide the driver with information on the route and surrounding condition of the vehicle from the digital room mirror.

A data collection unit 167 may function to collect and analyze the data collected using the camera 161, the sensor unit 163, the GPS 165, or the like. In this way, the data collection unit 167 may allow the control unit 11 to issue an instruction suitable for a vehicle state.

The control unit 11 may control the digital room mirror to display an appropriate image or an object to assist the driving in real time by synthesizing the data such as the speed of the vehicle, a driving mode, whether the lane marking change signal is detected, and the surrounding environment.

For example, the control unit 11 may adjust the screen based on the situation by controlling an LCD drive circuit 151, a backlight drive circuit 152, or the like based on the information collected by the data collection unit 167. In addition, the control unit 11 may be connected to a transmission device 13 to automatically display the image from the rear camera when the vehicle moves in reverse.

The transmission device 13 may detect a gear state, and the control unit 11 may automatically output the image from the rear camera on the digital room mirror when the vehicle moves in reverse. For example, the control unit 11 may immediately display the image from the rear camera on the room mirror when a reverse gear is recognized through the transmission device 13. Here, the control unit 11 may also be linked to the LCD drive circuit 151 and the backlight drive circuit 152 to thus control the screen to be clearly displayed.

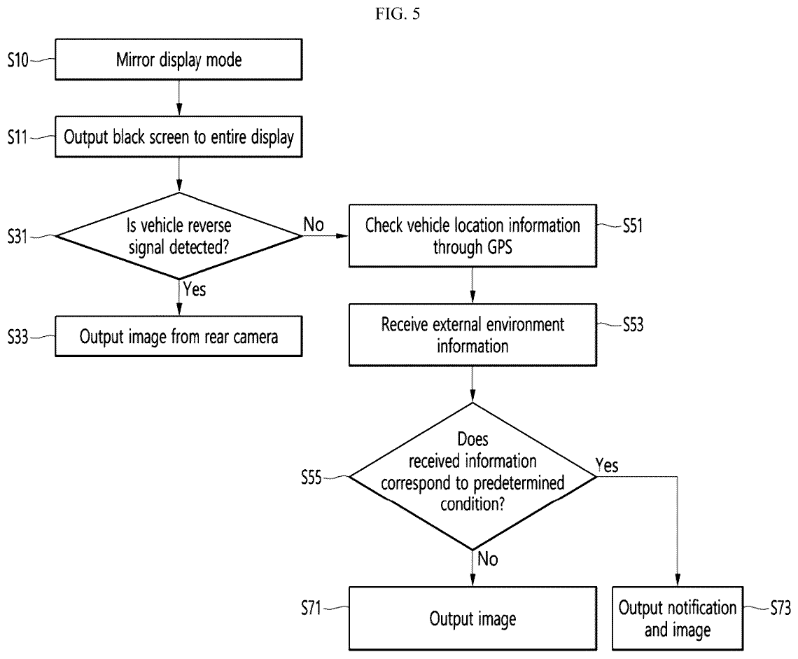

The mode selection unit 12 may select one of a mirror mode (FIG. 4(a)), a mirror display mode (FIG. 4(b)), and an LCD mode (FIG. 4(c)) as displayed in FIGS. 4(a)-4(c), and a selection criterion may be variously set by the above-described configurations. For example, the control unit 11 may control the mirror to be switched to the digital room mirror or to be maintained as the general mirror based on a mode selected by the driver through the mode selection unit 12.

A liquid crystal (LC) mirror 14 may be a mirror having a special structure enabling the mirror 14 to be operated as the general mirror and converted into the digital display as needed. The LC mirror 14 may be connected to an LC drive circuit 141, and switched to the digital room mirror as needed, thus providing the rear view accurately.

In addition, the LC drive circuit 141 may be linked to the control unit, and the control unit may control the mirror to be switched to the digital room mirror or maintained as the general mirror based on the mode selected by the driver through the mode selection unit 12, and control the LC mirror 14 to adjust the reflectivity, screen switching, or the like of the mirror through an electric signal.

The LCD drive circuit 151 may control an LCD module 15 to display the image entering from the rear camera to the driver. The LCD drive circuit 151 may function to adjust the brightness, color, contrast ratio, or the like of the display. The LCD drive circuit 151 may be linked to the control unit 11, and the control unit 11 may allow the image received from the camera 161 to be displayed on the screen accurately and clearly, and optimize the brightness and quality of the screen by operating the LCD drive circuit 151 together with the backlight drive circuit 152.

The backlight drive circuit 152 may be linked to the control unit 11, and the control unit 11 may control the backlight that provides light from behind the LCD screen for the screen to maintain appropriate brightness based on surrounding brightness. For example, the control unit 11 may automatically adjust the backlight brightness to allow the driver to see the screen brightly during the day and without the glare at night.

A communication unit 169 may communicate with an electronic control unit (ECU) of the vehicle and exchange information between the digital room mirror system and other systems in the vehicle. In this way, the digital room mirror may be operated integrally with other systems in the vehicle.

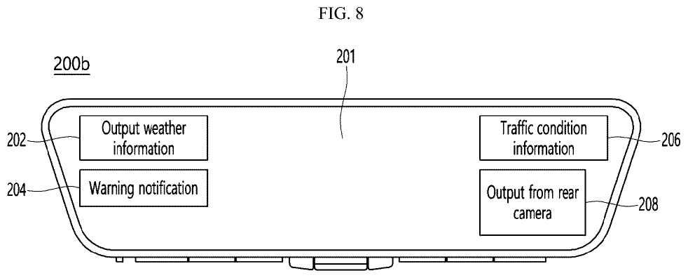

For example, the control unit 11 may receive real-time data from a traffic condition application programming interface (API) and a weather agency API through the communication unit 169, and receive information on road congestion and accidents through the traffic condition API to assist the driver to understand a traffic flow on his/her current route. In addition, the control unit 11 may receive real-time weather information through the weather agency API for the digital room mirror to automatically adjust the brightness or the screen display based on a weather change, thereby improving safety of the driving. The control unit 11 may also display the traffic conditions or the real-time weather information on the digital room mirror, which is described below with reference to FIGS. 6 to 8.

In addition, for example, the communication unit 169 may be connected to the control unit 11 and exchange various information such as the vehicle state, a driving speed, a transmission state, and the lane marking change signal detection. In this way, the communication unit 169 may transmit an instruction related to providing the rear view.

The LCD module 15 may provide the image received from the camera 161 to the driver in real time. The LCD module 15 may allow the driver to accurately check the rear situation or information for the convenience and safety of the driver through the high-resolution screen, may be linked to the LCD drive circuit 151, the backlight drive circuit 152, and the camera 161 to clearly output the rear image, receive the instruction from the control unit 11 to thus provide optimal visibility under various driving conditions, and may display various objects for the convenience and safety of the driver.

Through the above-described configuration, the camera 161 may capture the rear image in real time, and this image may be transmitted to the data collection unit 167. The sensor unit 163 may detect the surrounding environment of the vehicle and provide brightness or distance data, and the GPS 165 may provide the location and route information of the vehicle. All the data may be transmitted to the control unit 11, and the control unit 11 may thus control the LCD drive circuit 151 and the backlight drive circuit 152 based on the situation, and may optimize the screen brightness and the image quality. In addition, the control unit 11 may be connected to the transmission device 13 to allow the image from the rear camera to be automatically output to the LCD module 15 when the vehicle is in reverse, the mode selection unit 12 may select a desired mode of the driver and transmit the instruction to the control unit 11, and the control unit 11 may thus selectively display the image from the rear camera or perform the mirror function.

FIGS. 4(a)-4(c) are diagrams showing a control mode of the digital room mirror of a vehicle according to an embodiment of the present disclosure.

Mirror mode (FIG. 4(a)) is a mode for reflecting the rear situation as the mirror like a traditional room mirror without using a digital function, and reflecting the physical situation inside and behind the vehicle as it is like the general mirror while the digital display is turned off. The mirror mode (FIG. 4(a)) may be operated independently of power or an electronic system because this mode does not depend on the display.

The mirror display mode (FIG. 4(b)) is a hybrid mode for coupling the functions of the mirror and the digital display to each other. In this mode, some of the mirror functions may be maintained even when the digital display is turned on, and the driver may thus use the reflection function of the mirror while viewing the rear situation through the digital screen. Through this configuration, the driver may also check some parts not captured by the rear camera.

For example, in the mirror display mode (FIG. 4(b)), the object (e.g., character) may be expressed while maintaining the reflection function of the general mirror, like a screen 200a displayed on the digital room mirror of FIG. 7.

The LCD mode (FIG. 4(c)) may function to display the image captured by the rear camera 161 in real time on the LCD display. In this mode, the digital screen may use an entire area, and provide the driver with more information than the physical mirror through the wide viewing angle of the rear camera. The LCD mode may be useful in a dark environment or a situation where the viewing angle is limited, and the driver may see the rear situation clearly through the image from the camera.

Each of the above-described modes may be selected through the mode selection unit 12.

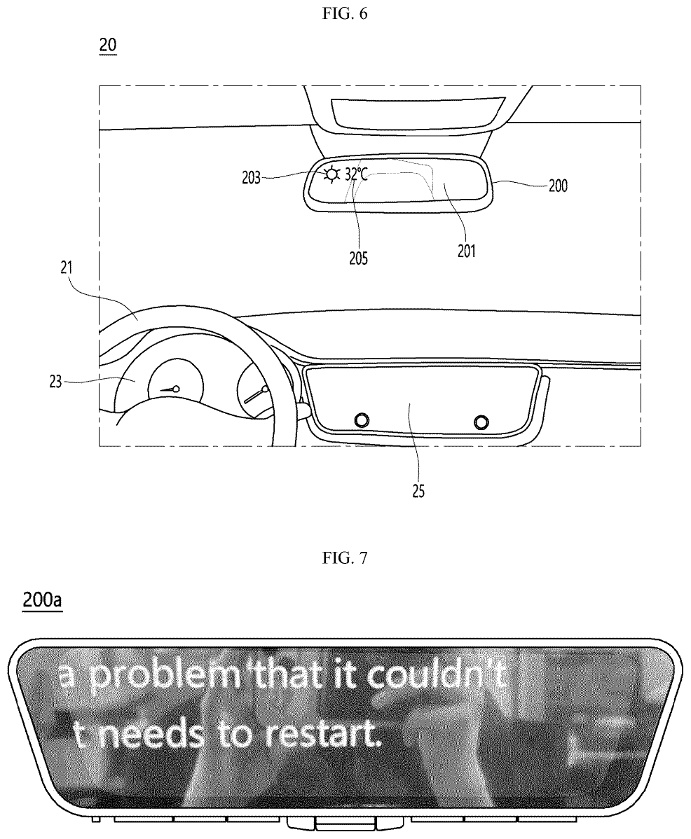

FIG. 5 is a diagram showing a control method of a digital room mirror of a vehicle according to an embodiment of the present disclosure; and FIGS. 6 to 8 are diagrams each showing an object displayed on the digital room mirror of a vehicle according to an embodiment of the control method in FIG. 5.

The following description may be provided with reference to FIGS. 3 and 5 to 8.

The control unit may output a black screen to the entire display (S11) when the mirror display mode (b) is selected through the mode selection unit 12 (S10). The black screen may be output to the entire display of the digital room mirror in the step (S11), thus allowing the driver to easily secure the viewing angle during the day or a bright environment and inhibit the glare when driving at night.

After the step (S11), the control unit 11 may determine whether a vehicle reverse signal is detected through the transmission device 13 (S31). If the reverse signal is detected (Yes in S31), the control unit 11 may output the rear image of the vehicle that is input through the camera 161 to the display (S33), thereby assisting the driver in driving in reverse.

Meanwhile, if the reverse signal is not detected (No in S31), the control unit 11 may check vehicle location information (S51) through the GPS 165, receive the external environment information (S53) through the communication unit 169, and determine whether the received information corresponds to a predetermined condition (S55).

The predetermined condition may be set as a condition in which a warning notification is to be provided to the driver based on precipitation, snowfall, snow cover, and new snow height checked based on the weather agency API information, and may include, for example, precipitation of 30 mm or more or new snow cover of 5 cm or more. In addition, the predetermined condition may include, for example, the traffic congestion, whether an accident occurs on a driving road, or the like checked using the traffic condition API information.

The control unit 11 may output the notification and the image (S73) if the received information corresponds to the predetermined condition (Yes in S55). The image output in the step (S73) may include the weather information or traffic condition information that serves as a basis for providing the warning notification to the driver. For example, the weather information may include the precipitation, the snowfall, or the like, and the traffic condition information may include whether an accident occurs on the driving road, whether a traffic jam occurs, or the like.

In addition, the control unit 11 may output the image (S71) if the received information does not correspond to the predetermined condition (No in S55). The image output in the step (S71) may include the weather information or the traffic condition information for the driver's driving assistance, and include, for example, the weather information or traffic condition of an area where the vehicle is currently disposed.

For example, the notification may be provided to the driver in various visual forms through the digital room mirror, and an example of outputting the received information as the image may be described below with reference to FIG. 6 and FIG. 8.

FIG. 6 may be a diagram showing an interior 20 of the vehicle. A steering device 21, an instrument panel 23, a display 25, and a digital room mirror 200 may be disposed in the interior of the vehicle. The display 25 may display vehicle state information, map information, or the like.

A display 201 of the digital room mirror 200 in this embodiment may be in the mirror display mode (b), thus reflecting the interior of the vehicle in the center, and showing an object 203 representing the external environment and an object 205 representing a temperature in an upper left corner.

For example, when viewing a digital room mirror 200b in FIG. 8, object information may be displayed on the left and right sides of the display 201 to thus inhibit the driver's viewing angle from being interfered, the weather information 202 may be output at the upper left corner as in FIG. 6, information 204 that visually notifies the driver of a warning may be output below the weather information 202 when the received weather agency API information corresponds to the predetermined condition, traffic condition information 206 may be output at an upper right corner, and the image 208 from the rear camera may be output at a lower right corner based on the reverse signal detection of the transmission device 13.

The output configuration of the object information described above is exemplary, and is not limited to the above-described location. For example, if the reverse signal is detected (Yes in S31), the rear camera may output the image in the center of the display 201 to improve user convenience in the reverse driving.

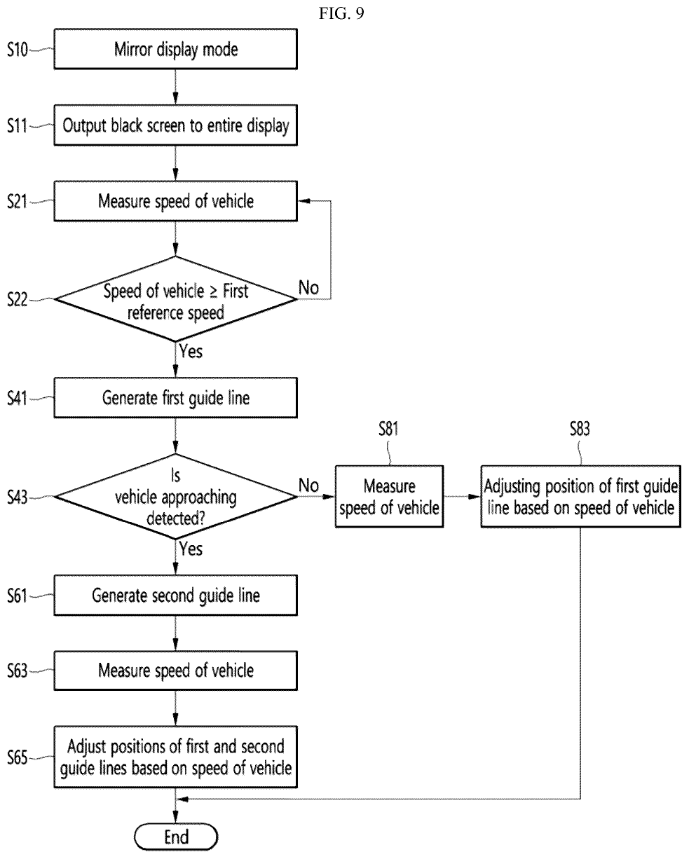

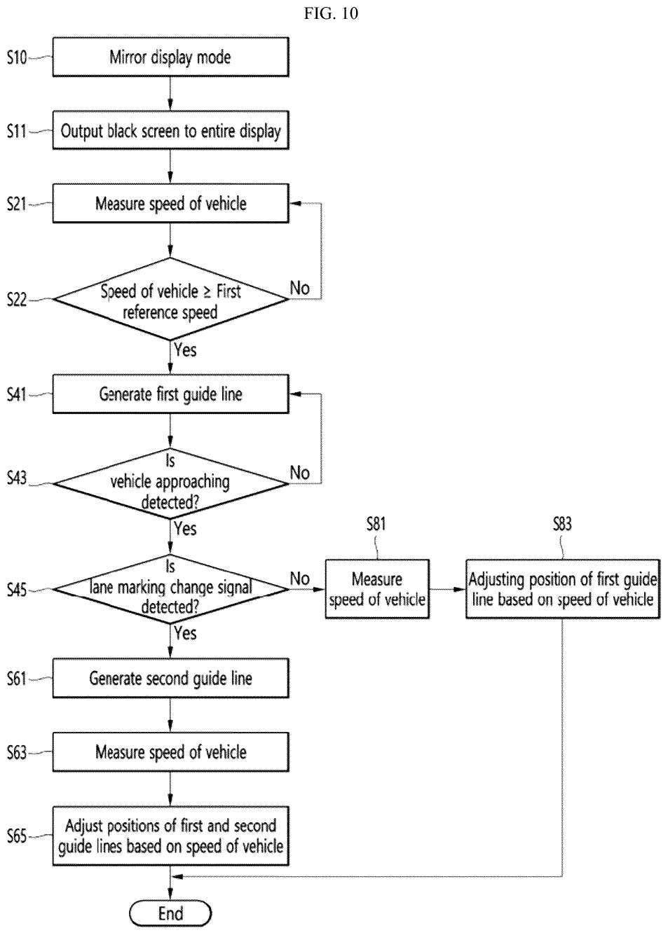

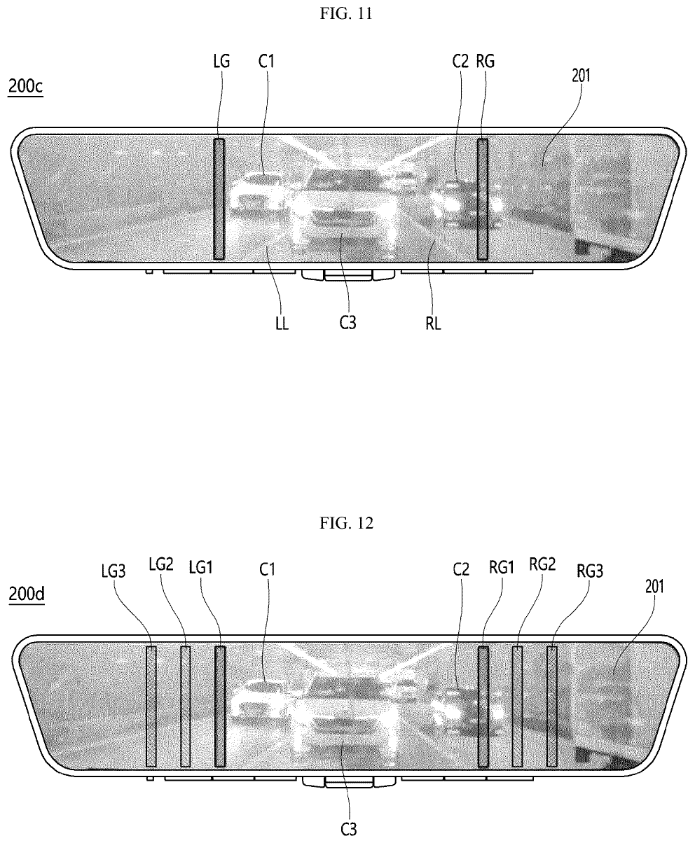

FIG. 9 is a diagram showing a control method of a digital room mirror of a vehicle according to an embodiment of the present disclosure; FIG. 10 is a diagram showing a control method of a digital room mirror of a vehicle according to an embodiment of the present disclosure; and FIGS. 11 to 13 are diagrams each showing an object displayed on the digital room mirror of a vehicle according to the control method in FIG. 9 or FIG. 10.

First, the following description may be provided with reference to FIGS. 3, 9, and 11 to 13.

The control unit may output the black screen to the entire display (S11) when the mirror display mode (b) is selected (S10) through the mode selection unit 12. The black screen may be output to the entire display of the digital room mirror in the step (S11), thus allowing the driver to easily secure the viewing angle during the day or the bright environment and inhibit the glare when driving at night.

After the step (S11), the control unit 11 may measure the speed of the vehicle through the sensor unit 163 (S21), and compare the measured speed of the vehicle with a predetermined first reference speed (S22).

If the measured speed of the vehicle is the predetermined first reference speed or more (Yes in S22), the control unit 11 may display first guide lines LG and RG on the digital room mirror as shown in FIG. 11.

The first reference speed may be set to determine whether the vehicle drives on the road and may use various reference speeds applied by the driver. For example, in relatively low-speed urban driving, the guide line (displayed object) described below may interfere with the driver's viewing angle, and an experienced driver may thus set the first reference speed high for the first guide lines to be generated in a high-speed driving condition (S41).

The pair of first guide lines LG and RG generated on a room mirror 200c in FIG. 11 may be displayed on the room mirror 200c based on lane markings LL and RL of the vehicle in driving. In more detail, the left first guide line LG may be displayed at a position corresponding to the left lane marking LL of the vehicle in driving, and the right first guide lines RG may be displayed at a position corresponding to the right lane marking RL of the vehicle in driving.

Meanwhile, the control unit 11 may generate the first guide lines (S41) and display the same on the room mirror, and then determine whether another vehicle approaching the vehicle in driving is detected (S43) through the sensor unit 163.

If the approach of another vehicle is detected (Yes in S43), the control unit 11 may generate a second guide line (S61) and display the same on the digital room mirror.

Referring to the guide lines generated on a room mirror 200d in FIG. 12, first guide lines LG1 and RG1 may be displayed at positions corresponding to the lane markings of the vehicle in driving, and a pair of second guide lines LG2 and RG2 may be displayed at positions respectively spaced apart from the lane markings in directions away from the lane markings based on the first guide lines LG1 and RG1.

The second guide lines LG2 and RG2 may be generated to secure a relative safety distance between the vehicle in driving and vehicles C1 and C2 approaching the vehicle in driving from other lane markings. In addition, the control unit 11 may also generate and display third guide lines LG3 and RG3 on the digital room mirror 200d.

For example, the third guide lines LG3 and RG3 may provide the notification to visually recognize the situation to the user in cases where the lane marking change signal of the vehicle in driving is detected, or vehicles C1, C2, and C3 approach faster than the speed of the vehicle in driving, the speed of the vehicle in driving is faster than a predetermined speed, or the like. For example, the third guide lines LG3 and RG3 may be lit periodically in the above-described cases.

In addition, the third guide lines LG3 and RG3 may provide the driver with a minimum standard for maintaining the safety based on a relative speed between the vehicle in driving and the vehicles C1 and C2, the approach speeds of the vehicles C1 and C2, the lane marking change signal detection of the vehicle, or the speed of the vehicle in driving. For example, the first guide lines LG1 and RG1 may be displayed on the digital room mirror 200d based on the lane markings of the vehicle in driving, the second guide lines LG2 and RG2 may be displayed at positions respectively spaced apart from the first guide lines LG1 and RG1 by a predetermined distance based on a driver setting, and the third guide lines LG3 and RG3 may be displayed based on the speed of the vehicle in driving, the speeds of the approaching vehicles C1 and C2, and the relative speed between the vehicle in driving and the approaching vehicles C1 and C2 when the lane marking change signal is detected.

That is, the third guide lines LG3 and RG3 may be displayed at positions close to the first guide lines LG1 and RG1 when the approaching vehicles C1 and C2 quickly approach the vehicle in driving and it is difficult to change the lane markings of the vehicle in driving for a safety reason, and the third guide lines LG3 and RG3 may be displayed at positions respectively spaced apart from the first guide lines LG1 and RG1 or the second guide lines LG2 and RG2 when it is easy to change the lane markings of the vehicle in driving in relation to the approaching vehicles C1 and C3.

In addition, the functions of the third guide lines LG3 and RG3 described above may also be performed by the second guide lines LG2 and RG2, in which case the two pairs of guide lines may be displayed. In more detail, this configuration is described by referring to the guide lines generated on a room mirror 200e in FIG. 13.

First guide lines LG4 and RG4 may be generated based on the lane markings of the vehicle as described above and displayed on the digital room mirror 200e. In addition, second guide lines LG5 and RG5 may respectively be generated and displayed in the directions away from the lane markings based on the first guide lines LG4 and RG4.

The second guide lines LG5 and RG5 in this embodiment may have positions displayed on the digital room mirror 200e changed as the speed of the vehicle is increased. In more detail, the second guide line LG5 or RG5 may be displayed by being moved in a direction of approaching the first guide line LG4 or RG4 as the speed of the vehicle is increased when the position of the second guide line LG5 or RG5 is changed. The control unit 11 may also generate objects (or arrows a1 and b1) to visually notify the driver that the positions of the second guide lines LG5 and RG5 are moved and displayed, and display the same on the digital room mirror 200e.

For the above-described control, the control unit 11 may generate the second guide lines and display the same on the digital room mirror (S61), then measure the speed of the vehicle through the sensor unit 163 (S63), and adjust the positions of the first and second guide lines based on the speed of the vehicle (S65).

For example, the speed of the vehicle that is measured in the step (S63) may indicate the speed of the vehicle in driving or the speeds of the approaching vehicles C1, C2, and C3, and the control unit 11 may also measure the relative speed between the vehicle in driving and the approaching vehicles by using each measured speed.

Referring to FIG. 13, in another embodiment of the present disclosure, the first guide lines and the second guide lines may indicate the same guide lines having different display positions. That is, LG4 and LG5 may both indicate the first guide lines displayed on a left side of the digital room mirror 200e, and RG4, RG5 may both indicate the first guide lines displayed on a right side of the digital room mirror 200e. Accordingly, in this embodiment, the pair of guide lines LG4 and RG4 and the pair of guide lines LG5 and RG5 may indicate the same objects a1 and b1 displayed based on the speed of the vehicle, and for convenience of explanation, FIG. 13 shows a state where all the guide lines are displayed on the display.

In another embodiment, the first guide line may be moved toward the inside of the lane marking of the vehicle in driving as the speed of the vehicle in driving is increased. That is, the pair of first guide lines may be moved in a direction of narrowing a width therebetween. The reason is that a lane marking deviation range may become wider due to a vehicle steering as the speed of the vehicle is increased, and it is thus safer to secure a long distance from a vehicle behind.

In addition, the first guide line may be moved toward the outside of the lane marking of the vehicle in driving as the speed of the vehicle in driving is decreased. That is, the pair of first guide lines may be moved in a direction of widening the width therebetween. The reason is that the lane marking deviation range may become narrower due to the vehicle steering as the speed of the vehicle is decreased, and it may thus be safe to secure even a relatively close distance from the vehicle behind.

Meanwhile, in the step (S65), the position of the second guide line may also be adjusted according to the same principle as the position of the first guide line described above, and in this case, the second guide line may indicate an object different from the first guide line.

For example, the first guide line may be formed based on the lane marking of the vehicle in driving, and have the display position moved slightly inward or outward of the lane marking based on the speed of the vehicle in driving, and the second guide line may be displayed by being moved in the direction away from or closer to the first guide line based on the speed of the vehicle in driving, the speed of the approaching vehicle, or the relative speed between the vehicle in driving and the approaching vehicle.

Meanwhile, if the approach of the vehicle is not detected in the step (S45) (No in S45), the control unit 11 may measure the speed of the vehicle (S81) through the sensor unit 163, and display the first guide line on the digital room mirror (S83) by adjusting its position based on the speed of the vehicle. The speed measured in the step (S81) may indicate the speed of the vehicle in driving.

FIG. 10 is a diagram showing a control method of a digital room mirror of a vehicle according to an embodiment of the present disclosure, and the description mainly describes the differences and omits content already described with reference to FIG. 9.

The control unit 11 may determine whether the lane marking change signal of the vehicle in driving is detected (S45) if the approach of the vehicle is detected through the sensor unit 163 (Yes in S43).

In addition, if the lane marking change signal is detected (Yes in S45), the control unit 11 may generate the second guide line and display the same on the digital room mirror (S61), measure the speed of the vehicle (S63), and then display the guide lines on the digital room mirror (S65) by adjusting the positions of the first and second guide lines based on the speed of the vehicle for the safety and convenience of the driver.

The speed of the vehicle that is measured in the step (S63) may indicate at least one of the speed of the vehicle in driving, the speed of the approaching vehicle, or the relative speed between the vehicle in driving and the approaching vehicle, as described above.

Meanwhile, if the lane marking change signal is not detected in the step (S45) (No in S45), the control unit 11 may measure the speed of the vehicle (S81) through the sensor unit 163, and display the first guide line on the digital room mirror for the safety and convenience of the driver (S83) by adjusting adjust its position based on the speed of the vehicle.

The speed of the vehicle that is measured in the step (S81) can indicate the speed of the vehicle in driving as described above.

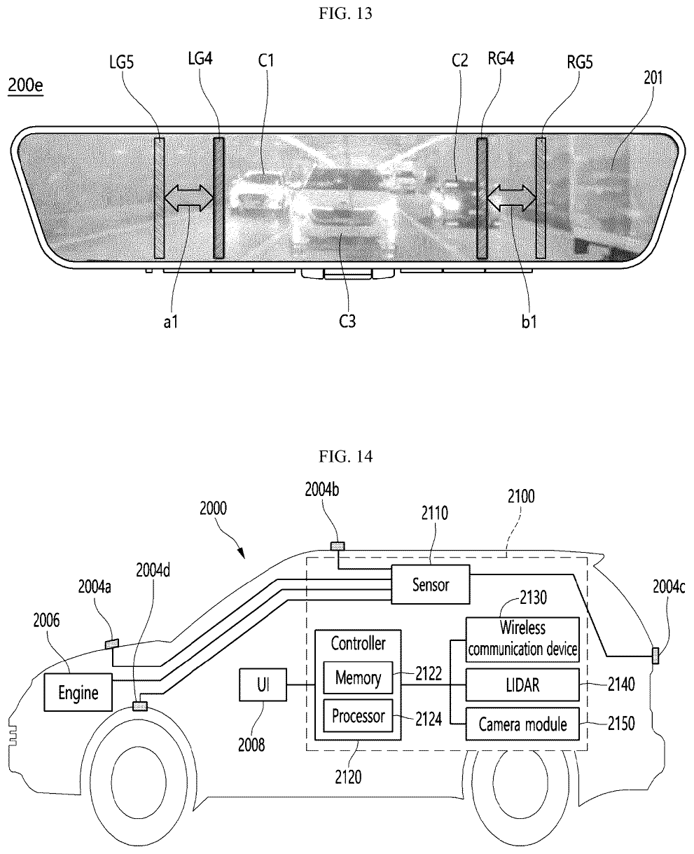

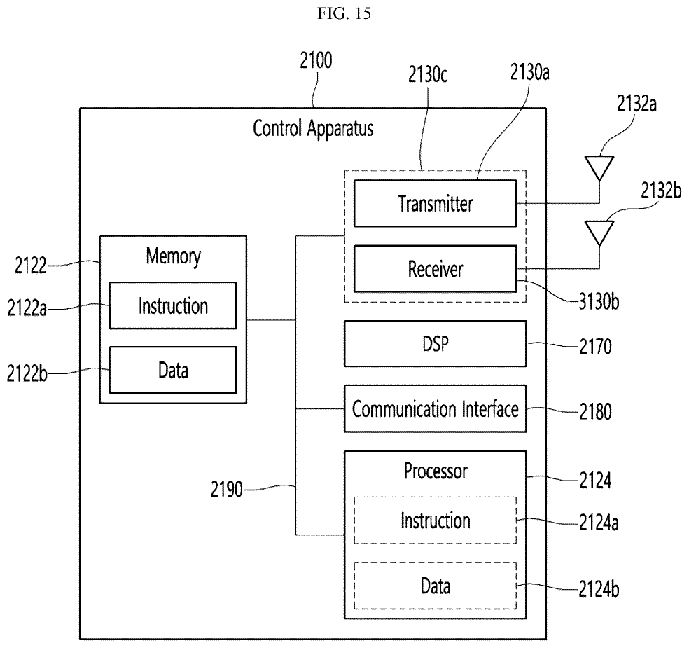

FIG. 14 is a block diagram showing a vehicle 2000 mounted with the digital rear mirror device according to an embodiment of the present disclosure. FIG. 15 is a block diagram showing a control apparatus 2100 of the vehicle in FIG. 14.

Referring to FIGS. 14 and 15, the vehicle 2000 may be mounted with the digital room mirror according to the embodiments, and may include the control apparatus 2100. Here, the vehicle 2000 may be an autonomous vehicle. In some embodiments, at least one component of the digital room mirror may be integrated into at least one component of the control apparatus 2100.

The control apparatus 2100 may include a controller 2120 including a memory 2122 and a processor 2124, a sensor 2110, a wireless communication device 2130, a light detection and ranging (LIDAR) device 2140, and a camera module 2150.

The controller 2120 may be configured by a manufacturer of the vehicle at the time of manufacture or may be further configured after the manufacture to perform an autonomous driving function. Alternatively, the controller 2120 configured at the time of manufacture may be upgraded to include a configuration for performing a continuous additional function.

The controller 2120 may transmit a control signal to other components within the vehicle, including the sensor 2110, an engine 2006, a user interface (UI) 2008, the wireless communication device 2130, the LIDAR sensor 2140, and the camera module 2150. In addition, although not shown, the controller 2120 may also transfer the control signal to an accelerator, a braking system, a steering device, or a navigation device, associated with the driving of the vehicle.

The controller 2120 may control the engine 2006. For example, the controller 2120 may detect a speed limit of a road on which the vehicle 2000 drives, control the engine 2006 for a driving speed not to exceed the speed limit, or control the engine 2006 to accelerate the driving speed of the vehicle 2000 within a range that does not exceed the speed limit. In addition, when a sensing module 2004a, 2004b, 2004c, or 2004d detects an external environment of the vehicle and transfers the same to the sensor 2110, the controller 2120 may receive information on the external environment and generate a signal to control the engine 2006 or the steering device (not shown), thereby controlling the driving of the vehicle.

The controller 2120 may control the engine 2006 or the braking system to decelerate the driving vehicle when another vehicle or an obstacle exists in front of the vehicle, and control the trajectory, driving path, and steering angle of the vehicle in addition to its speed. Alternatively, the controller 2120 may control the driving of the vehicle by generating a necessary control signal based on recognition information of other external environments such as the driving lane marking and driving signal of the vehicle.

The controller 2120 may also control the driving of the vehicle by communicating with a surrounding vehicle or a central server in addition to generating its own control signal, and transmitting an instruction to control a surrounding device based on the received information.

In addition, it may be difficult to accurately recognize the vehicle or the lane marking when changing the position or angle of view of the camera module 2150. Therefore, the controller 2120 may generate the control signal to control calibration of the camera module 2150 to inhibit this difficulty. Therefore, the controller 2120 may generate the calibration control signal to the camera module 2150, thereby continuously maintaining the normal mounting position, direction, angle of view, or the like of the camera module 2150 even if the mounting position of the camera module 2150 is changed due to vibration or impact caused by a movement of the autonomous vehicle 2000. The controller 2120 may generate the control signal to perform the calibration of the camera module 2150 when the pre-stored initial mounting position, direction, or angle of view information of the camera module 2150 and the initial mounting position, direction, angle of view information, or the like of the camera module 2150 that is measured during the driving of the autonomous vehicle 2000 are different from each other by a threshold value or more.

The controller 2120 may include the memory 2122 and the processor 2124. The processor 2124 may execute software stored in the memory 2122 based on the control signal of the controller 2120. In detail, the controller 2120 may store, in the memory 2122, data and instructions for detecting a viewing angle image from the rear image of the vehicle 2000, and the instructions may be executed by the processor 2124 to implement one or more methods disclosed herein.

Here, the memory 2122 may be stored on a non-volatile storage medium executable by the processor 2124. The memory 2122 may store software and data through an appropriate internal or external device. The memory 2122 may include the memory device 2122 connected to a random access memory (RAM), a read only memory (ROM), a hard disk, or a dongle.

The memory 2122 may store at least an operating system (OS), a user application, and executable instructions. The memory 2122 may also store application data and array data structures.

The processor 2124 may be a microprocessor or a suitable electronic processor, the controller, a microcontroller, or a state machine.

The processor 2124 may be implemented as a combination of computing devices, and the computing device may be a digital signal processor, the microprocessor, or a suitable combination thereof.

In addition, the control apparatus 2100 may monitor an internal or external feature of the vehicle 2000 and detect its state by using at least one sensor 2110.

The sensor 2110 may include at least one sensing module 2004, and the sensing module 2004 may be disposed at a specific position of the vehicle 2000 based on a detection purpose. The sensing module 2004 may be disposed at the bottom, rear, front, top, or side of the vehicle 2000, and also be disposed at the internal part, tire, or the like of the vehicle.

In this way, the sensing module 2004 may detect driving information, such as the engine 2006, tire, steering angle, speed, and weight of the vehicle, as internal information of the vehicle. In addition, at least one sensing module 2004 may include an accelerometer sensor 2110, a gyroscope, an image sensor 2110, a radio detection and ranging (RADAR) sensor, an ultrasonic sensor, the LiDAR sensor, or the like, and may detect movement information of the vehicle 2000.

The sensing module 2004 may also receive, as external information, specific data on a state of the external environment, such as information on a state of a road where the vehicle 2000 is disposed, information on the surrounding vehicle, and the weather, and detect a parameter of the vehicle based thereon. The detected information may be stored in the memory 2122 for a short or long term based on the purpose.

The sensor 2110 may collect information from the sensing modules 2004 that are generated inside and outside the vehicle 2000.

The control apparatus 2100 may further include the wireless communication device 2130.

The wireless communication device 2130 may be configured to implement wireless communication of the vehicle 2000. For example, the wireless communication device 2130 may enable the vehicle 2000 to communicate with a user mobile phone, or another wireless communication device 2130, another vehicle, a central device (traffic control apparatus), a server, or the like. The wireless communication device 2130 may transmit and receive a wireless signal according to a wireless access protocol. The wireless communication protocol may be, Wi-Fi, Bluetooth, long-term evolution (LTE), code division multiple access (CDMA), wideband code division multiple access (WCDMA), or global systems for mobile communications (GSM), and is not limited thereto.

In addition, the vehicle 2000 may also implement inter-vehicle communication through the wireless communication device 2130. That is, the wireless communication device 2130 may communicate with another vehicle or other vehicles on the road based on vehicle-to-vehicle (V2V) communication. The vehicle 2000 may transmit and receive information such as driving warnings and traffic information through the vehicle-to-vehicle communication, and request information or receive a request from other vehicles. For example, the wireless communication device 2130 may perform the V2V communication by using a dedicated short-range communication (DSRC) device or a cellular-V2V (C-V2V) device. In addition, the wireless communication device 2130 may also implement communication (vehicle to everything (V2X) communication) between the vehicle and another object (for example, an electronic device carried by a pedestrian) in addition to the communication between the vehicles.

In addition, the control apparatus 2100 may include the LIDAR device 2140. The LIDAR device 2140 may detect a surrounding object of the vehicle 2000 during its operation by using data sensed by the LIDAR sensor. The LIDAR device 2140 may transmit detected information to the controller 2120, and the controller 2120 may operate the vehicle 2000 based on the detected information. For example, the controller 2120 may instruct the vehicle to reduce its speed using the engine 2006 when the detection information indicates a slow-moving vehicle ahead. Alternatively, the controller 2120 may instruct the vehicle to reduce its entry speed based on a curvature of the curve into which the vehicle enters.

The control apparatus 2100 may further include the camera module 2150. The control apparatus 2100 may extract the object information from an external image captured by the camera module 2150, and cause the controller 2120 to process the information.

In addition, the control apparatus 2100 may further include an imaging device for recognizing the external environment. The control apparatus 2100 may use the RADAR device, a global positioning system (GPS) device, a driving distance measurement device (Odometry), or another computer vision device in addition to the LIDAR device 2140, and these devices may be operated selectively or simultaneously as needed to enable more precise detection.

The vehicle 2000 may further include the user interface 2008 for a user input to the control apparatus 2100 described above. The user interface 2008 may allow the user to input information through appropriate interaction. For example, the user interface 2008 may be implemented as a touch screen, a keypad, the manipulation button, or the like. The user interface 2008 may transmit the user input or command to the controller 2120, and the controller 2120 may perform a vehicle control operation in response to the input or command.

In addition, the user interface 2008 may allow the vehicle 2000 to communicate with a device outside the vehicle 2000 through the wireless communication device 2130. For example, the user interface 2008 may enable the vehicle 2000 to interact with the mobile phone, a tablet, or another computing device.

Furthermore, although the vehicle 2000 is described as including the engine 2006, the vehicle 2000 may also include a different type of propulsion system. For example, the vehicle may be powered by electric energy, hydrogen energy, or a hybrid system combining the two energies. Therefore, the controller 2120 may include a propulsion mechanism based on a propulsion system of the vehicle 2000, and provide the control signal based thereon to each component of the propulsion mechanism.

Hereinafter, referring to FIG. 15, the description describes in more detail a detailed configuration of the control apparatus 2100 that controls the digital rear mirror of the vehicle 2000.

The control apparatus 2100 may include the processor 2124. The processor 2124 may be a general-purpose single or multi-chip microprocessor, a dedicated microprocessor, the microcontroller, a programmable gate array, or the like. The processor may be referred to as a central processing unit (CPU). In addition, the processor 2124 may also be used in a combination of the plurality of processors.

The control apparatus 2100 may also include the memory 2122. The memory 2122 may be any electronic component capable of storing electronic information. The memory 2122 may also include a combination of the memories 2122 in addition to a single memory.

According to the various embodiments, the memory 2122 may also store data and instructions 2122a for detecting a viewing angle image 220 from the rear image 210 of the vehicle 2000. When the processor 2124 executes the instructions 2122a, all or part of the instructions 2122a and data 2122b necessary to perform the instructions may be loaded into instructions 2124a and data 2124b of the processor 2124.

The control apparatus 2100 may include a transmitter 2130a, a receiver 2130b, or a transceiver 2130c to allow transmission and reception of signals. One or more antennas 2132a and 2132b may be electrically connected to the transmitter 2130a, the receiver 2130b, or each transceiver 2130c, and may also include additional antennas.

The control apparatus 2100 may also include a digital signal processor (DSP) 2170. The control apparatus 2100 may enable the vehicle to rapidly process a digital signal by using the DSP 2170.

The control apparatus 2100 may also include a communication interface 2180. The communication interface 2180 may include one or more ports and/or communication modules for connecting other devices to the control apparatus 2100. The communication interface 2180 may enable the user to interact with the control apparatus 2100.

The various components of the control apparatus 2100 may be connected with each other by one or more buses 2190, and the buses 2190 may include a power bus, a control signal bus, a state signal bus, a data bus, and the like. The components may communicate information to each other through the bus 2190 and may each perform an intended function under the control of the processor 2124.

Hereinabove, the description mainly describes the preferred embodiments of the present disclosure. All the embodiments and conditional examples disclosed in the specification have been described to intend to assist in the understanding of the principle and concept of the present disclosure by those skilled in the art to which the present disclosure pertains. Therefore, it will be understood by those skilled in the art that the present disclosure may be implemented in modified forms without departing from the spirit and scope of the present disclosure.

Therefore, the embodiments disclosed herein should be considered in an illustrative aspect rather than a restrictive aspect. It should be understood that the scope of the present disclosure is defined by the patent claims, not by the detailed description provided above, and includes any modifications within this scope.

Meanwhile, the methods according to the various embodiments of the present disclosure described above may be implemented as a program and provided to a server or a device. Therefore, each apparatus may access the server or the device that stores the program to download the program.

In addition, the methods according to the various embodiments of the present disclosure described above may be implemented as a program, and stored and provided in various non-transitory computer readable media. The non-transitory computer readable medium is not a medium that temporarily stores data therein, such as a register, a cache, or a memory, and indicates a medium that semi-permanently stores data therein and is readable by the device. In detail, the various applications or programs described above may be stored and provided in the non-transitory computer readable medium such as a compact disk (CD), a digital versatile disk (DVD), a hard disk, a Blu-ray disk, a universal serial bus (USB), a memory card, or a read only memory (ROM).

In addition, although the preferred embodiments are shown and described in the present disclosure as above, the present disclosure is not limited to the above-mentioned specific embodiments, and may be variously modified by those skilled in the art to which the present disclosure pertains without departing from the gist of the present disclosure as claimed in the accompanying claims. These modifications should also be understood to fall within the scope and spirit of the present disclosure.

### DESCRIPTION OF REFERENCE NUMERALS IN THE DRAWINGS

10: A digital room mirror control apparatus
200: A digital room mirror

1. A control method of a digital room mirror of a vehicle, the method comprising:
determining whether a reverse signal of the vehicle is detected through a transmission device;
checking vehicle location information if the reverse signal is not detected;
receiving external environment information based on the vehicle location information; and
determining whether the external environment information corresponds to a predetermined condition,
wherein the external environment information on the room mirror is displayed by a control unit of the vehicle, based on whether the external environment information corresponds to the predetermined condition.

2. The method of claim 1, wherein the external environment information includes weather information or traffic condition information, based on the vehicle location information.

3. The method of claim 1, wherein the external environment information is displayed on the room mirror and a notification is provided to a driver, by the control unit, if the external environment information corresponds to the predetermined condition.

4. The method of claim 2, wherein a notification is displayed on the room mirror.

5. A control method of a digital room mirror of a vehicle, the method comprising:
measuring a speed of the vehicle being driven;
comparing the measured speed of the vehicle with a predetermined reference speed;
displaying a guide line on the digital room mirror by a control unit of the vehicle if the measured speed of the vehicle is a predetermined reference speed or more; and
detecting another vehicle approaching the vehicle being driven,
wherein a position of the guide line is adjusted by the control unit when another vehicle approaching the vehicle being driven is detected.

6. The method of claim 5, wherein a pair of first guide lines are displayed on the room mirror based on lane markings of the vehicle in driving.

7. The method of claim 6, wherein a plurality of pairs of guide lines are displayed when another approaching vehicle is detected.

8. The method of claim 7, wherein the guide lines include
the pair of first guide lines displayed based on the lane markings of the vehicle being driven, and
a pair of second guide lines displayed at positions respectively spaced apart from the lane markings in directions away from the lane markings based on the pair of first guide lines.

9. The method of claim 8, wherein the second guide lines are displayed by being moved in a direction closer to the first guide lines, respectively, as the speed of the vehicle being driven is increased.

10. The method of claim 6, further comprising determining whether a lane marking change signal of the vehicle being driven is detected if another vehicle is detected.

11. The method of claim 10, wherein a plurality of pairs of guide lines are displayed when the lane marking change signal is detected.

12. The method of claim 11, wherein the guide lines include
the pair of first guide lines displayed based on the lane markings of the vehicle being driven, and
a pair of second guide lines displayed at positions respectively spaced apart from the lane markings in directions away from the lane markings based on the pair of first guide lines.

13. The method of claim 12, wherein the second guide lines are displayed by being moved in a direction closer to the first guide lines, respectively, as the speed of the vehicle being driven is increased.

14. (canceled)

15. (canceled)

16. A digital room mirror control apparatus of a vehicle, the apparatus comprising:
a digital room mirror driven in at least two modes based on an electrical signal that is selectively input;
a sensor unit configured to detect a speed of the vehicle being driven, approach of another vehicle, or a lane marking change signal of the vehicle being driven;
a camera configured to capture an external environment of the vehicle being driven; and
a control unit configured to generate a captured image or an object for the convenience and safety of a driver and to display the generated image or object on the digital room mirror,
wherein the control unit displays a guide line on the digital room mirror based on at least one of the speed of the vehicle being driven, the approach of another vehicle, or the lane marking change signal of the vehicle being driven that is measured through the sensor unit.

17. The apparatus of claim 16, wherein a pair first guide lines are displayed on the room mirror based on lane markings of the vehicle being driven.

18. The apparatus of claim 17, wherein a plurality of pairs of guide lines are displayed when detecting another approaching vehicle.

19. The apparatus of claim 18, wherein the guide lines include
the pair of first guide lines displayed based on the lane markings of the vehicle in driving, and
a pair of second guide lines displayed at positions respectively spaced apart from the lane markings in directions away from the lane markings based on the pair of first guide lines.

20. The apparatus of claim 19, wherein the second guide lines are displayed by being moved in a direction closer to the first guide lines, respectively, as the speed of the vehicle is increased.
